(19) United States
(12) Patent Application Publication
(10) Pub. No.: US 2026/0243741 A1
(43) Pub. Date: Aug. 20, 2026

(54) ANALYTICAL INSTRUMENT

(71) Applicant: SHIMADZU CORPORATION, Kyoto-shi (JP)

(72) Inventors: Kazuma MAEDA, Kyoto-shi (JP); Kazuo MUKAIBATAKE, Kyoto-shi (JP); Keisuke ISO, Kyoto-shi (JP); Takanari HATTORI, Kyoto-shi (JP)

(21) Appl. No.: 19/473,432

(22) PCT Filed: Apr. 18, 2023
(86) PCT No.: PCT/JP2023/015492

§ 371 Date: Oct. 7, 2025

(51) Int. Cl. G01N 30/72; B01D 15/10; G01N 30/02; G01N 30/86

(52) U.S. Cl. CPC G01N 30/7233; B01D 15/102; G01N 30/8624; G01N 2030/027

(57) ABSTRACT

An analytical instrument 100 includes at least one of a chromatograph and a mass spectrometer, and comprises a sensor 16, 25, 26, a storage unit 32, and a comparison processing unit 311. The sensor 16, 25, 26 detects a state of the analytical instrument 100 and outputs a sensor value corresponding to the state. The storage unit 32 stores sensor value data representing a temporal change of the sensor value with an elapse of analysis time. The comparison processing unit 311 compares, for a plurality of pieces of the sensor value data obtained by performing analysis a plurality of times under the same analysis conditions, a difference in the sensor value at the same analysis time, or a difference in a value representing a change in the sensor value in the same analysis time range, with a threshold value.

### TECHNICAL FIELD

The present invention relates to an analytical instrument including at least one of a chromatograph and a mass spectrometer.

### BACKGROUND ART

When performing an analysis using an analytical instrument, an accurate analysis result may not be obtained depending on the state of the analytical instrument. Therefore, an analytical instrument has been proposed that is equipped with a function capable of determining whether the analytical instrument is in a normal state by comparing each control value in the analytical instrument with a reference value. In this case, the reference value is an absolute value.

Patent Literature 1 below proposes a technology for making it easier to recognize changes in the performance of an analytical instrument whose performance is gradually deteriorating, as a method for confirming whether the performance of the analytical instrument maintains a reference value. Specifically, a technology is proposed in which index information that serves as an indicator of the performance of the analytical instrument is arranged and output in chronological order, and a predetermined warning is issued according to a determination result of whether the index information has exceeded a preset threshold value.

In addition, Patent Literature 2 below proposes a technology for calculating the reliability of a correction of a space charge effect based on a mass spectrum and comparing this reliability with a predetermined threshold value, regarding the space charge effect, which is a phenomenon that affects mass spectrometry.

### CITATION LIST

### Patent Literatures

[Patent Literature 1] Japanese Unexamined Patent Application Publication No. 2020-193824
[Patent Literature 2] Japanese Unexamined Patent Application Publication No. 2014-59964

### SUMMARY OF INVENTION

### Technical Problem

However, even in cases where the instrument is determined to be normal by comparing each parameter with a threshold value consisting of an absolute value, it is not uncommon to find that an accurate analysis result has not been obtained upon checking the analysis result. Therefore, there is a demand for a technology that can determine the state of the analytical instrument with higher accuracy in order to more reliably obtain accurate analysis results.

The present invention has been made in view of the above circumstances, and an object of the present invention is to provide an analytical instrument that can determine the state of the analytical instrument with higher accuracy.

### Solution to Problem

A first aspect of the present invention is an analytical instrument including at least one of a chromatograph and a mass spectrometer, the analytical instrument comprising a sensor, a storage unit, and a comparison processing unit. The sensor detects a state of the analytical instrument and outputs a sensor value corresponding to the state. The storage unit stores sensor value data representing a temporal change of the sensor value with an elapse of analysis time. The comparison processing unit compares, for a plurality of pieces of the sensor value data obtained by performing analysis a plurality of times under the same analysis conditions, a difference in the sensor value at the same analysis time, or a difference in a value representing a change in the sensor value in the same analysis time range, with a threshold value.

A second aspect of the present invention is an analytical instrument including at least one of a chromatograph and a mass spectrometer, the analytical instrument comprising a sensor, a storage unit, and a comparison processing unit. The sensor detects a state of the analytical instrument and outputs a sensor value corresponding to the state. The storage unit stores sensor value data representing a temporal change of the sensor value with an elapse of analysis time. The comparison processing unit compares, for a plurality of pieces of the sensor value data obtained by performing analysis a plurality of times under the same analysis conditions, a difference between images representing each piece of sensor value data in the same analysis time range, with a threshold value.

### Advantageous Effects of Invention

According to the present invention, the state of the analytical instrument can be determined with higher accuracy based on the comparison result by the comparison processing unit.

### BRIEF DESCRIPTION OF DRAWINGS

FIG. 1 is a schematic diagram showing an embodiment of an analytical instrument.

FIG. 2 is a block diagram showing an example of the electrical configuration of the analytical instrument.

FIG. 3A is a diagram for explaining an example of processing by a comparison processing unit, showing sensor value data of the degree of vacuum when the analytical instrument is normal.

FIG. 3B is a diagram for explaining an example of processing by the comparison processing unit, showing sensor value data of the degree of vacuum when the analytical instrument is abnormal.

FIG. 4A is a diagram for explaining another example of processing by the comparison processing unit, showing sensor value data of the interface current when the analytical instrument is normal.

FIG. 4B is a diagram for explaining another example of processing by the comparison processing unit, showing sensor value data of the interface current when the analytical instrument is abnormal.

FIG. 5 is a diagram for explaining an example of processing by a display processing unit.

FIG. 6 is a diagram for explaining another example of processing by the display processing unit.

### DESCRIPTION OF EMBODIMENTS

### 1. Overall Configuration of Analytical Instrument

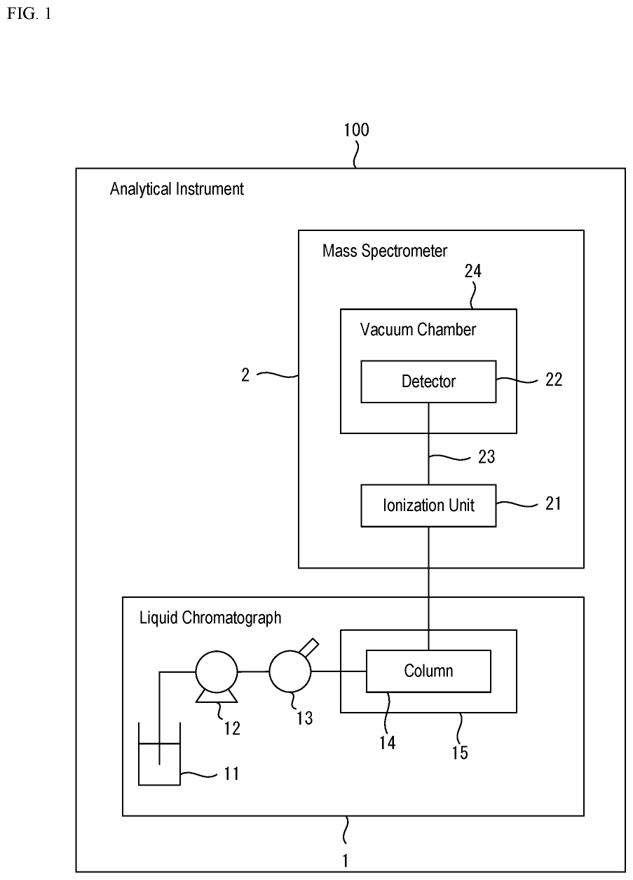

FIG. 1 is a schematic diagram showing an embodiment of an analytical instrument 100. This analytical instrument 100 is an apparatus in which a liquid chromatograph 1 and a mass spectrometer 2 are combined, and a liquid sample is introduced into the mass spectrometer 2 via the liquid chromatograph 1.

The liquid chromatograph 1 includes a mobile phase reservoir 11, a pump 12, a sample injection device 13, a column 14, a column oven 15, and the like. The mobile phase reservoir 11 stores a mobile phase made of a liquid such as an organic solvent. The mobile phase in the mobile phase reservoir 11 is sent out by the driving of the pump 12 and supplied to the column 14. The pump 12 is a liquid-sending pump constituted by, for example, a high-pressure pump, and sends out the mobile phase from within the mobile phase reservoir 11 at a set pressure.

A liquid sample is injected from the sample injection device 13 into the mobile phase supplied to the column 14 at an arbitrary timing. As a result, the liquid sample is supplied to the column 14 together with the mobile phase. The column 14 is housed in the column oven 15. The inside of the column oven 15 is heated by a heater (not shown), and in the process where the liquid sample passes through the column 14 heated in the column oven 15 together with the mobile phase, each component in the liquid sample is temporally separated.

The liquid sample that has passed through the column 14 is introduced into the mass spectrometer 2 in a state where each component in the liquid sample has been separated. That is, each separated component in the liquid sample is sequentially introduced from the liquid chromatograph 1 to the mass spectrometer 2.

The mass spectrometer 2 includes an ionization unit 21, a detector 22, and the like. Each component in the liquid sample introduced from the liquid chromatograph 1 into the mass spectrometer 2 is ionized in the ionization unit 21 and then supplied into a vacuum chamber 24 via an interface 23. A voltage is applied to the interface 23, so that analysis is performed in a state where a set current (interface current) flows through the interface 23.

During analysis, the inside of the vacuum chamber 24 is depressurized by a vacuum pump (not shown) to be in a vacuum state. In the vacuum chamber 24, in addition to the detector 22, for example, an ion lens, a quadrupole mass spectrometer, and the like (all not shown) are provided. The ions introduced from the ionization unit 21 into the vacuum chamber 24 via the interface 23 are separated according to their mass-to-charge ratio and detected by the detector 22. As a result, a chromatogram as analysis data is obtained.

Note that parameters such as the set pressure of the pump 12, the set temperature in the column oven 15, the set current of the interface 23, or the set pressure in the vacuum chamber 24 are examples of analysis conditions, but the analysis conditions may include various other parameters.

### 2. Electrical Configuration of Analytical Instrument

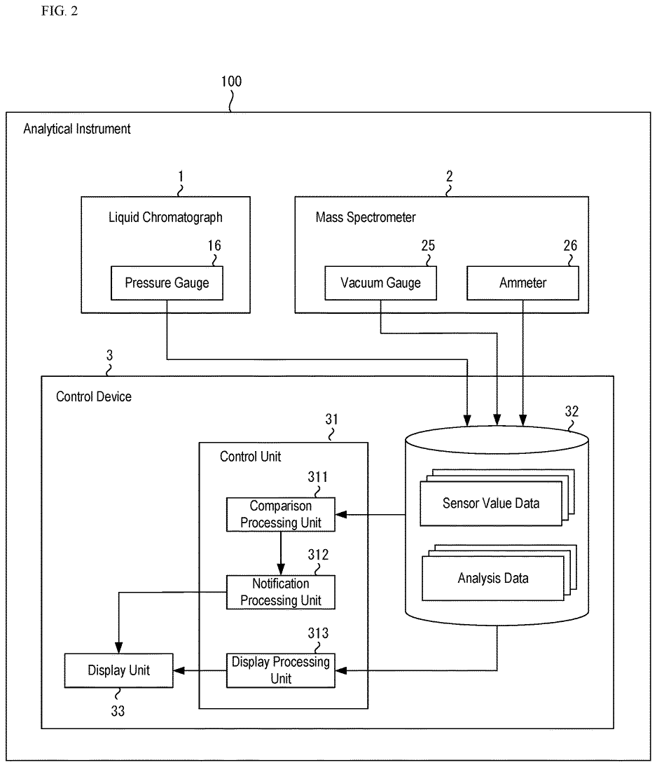

FIG. 2 is a block diagram showing an example of the electrical configuration of the analytical instrument 100. The operation of this analytical instrument 100 is controlled by a control device 3. The control device 3 includes a control unit 31, a storage unit 32, a display unit 33, and the like.

The control unit 31 is electrically connected to the storage unit 32 and the display unit 33. The storage unit 32 includes, for example, a ROM (Read Only Memory), a RAM (Random Access Memory), or a hard disk, and stores computer programs as well as necessary data. The display unit 33 includes, for example, a liquid crystal display.

The storage unit 32 stores signals (sensor values) output from various sensors provided in the liquid chromatograph 1 and the mass spectrometer 2. The sensor value is an output value from a sensor for detecting the state of the analytical instrument 100 (such as the liquid chromatograph 1 or the mass spectrometer 2), and is distinguished from the output value (analysis data) from the detector 22 in that it is a value corresponding to the state of the analytical instrument 100.

Examples of the sensors include a pressure gauge 16 provided in the liquid chromatograph 1, or a vacuum gauge 25 or an ammeter 26 provided in the mass spectrometer 2. The pressure gauge 16 detects the pump pressure (discharge pressure) of the pump 12. The vacuum gauge 25 detects the degree of vacuum based on the pressure inside the vacuum chamber 24. The ammeter 26 detects the current (interface current) flowing through the interface 23.

The sensor values output from these sensors are associated with the elapsed time during analysis (analysis time) and stored in the storage unit 32 as data representing the temporal change of the sensor value with the elapse of analysis time (sensor value data). That is, the storage unit 32 stores sensor value data separately from the analysis data. When analysis is performed multiple times, the analysis data and sensor value data for each analysis are associated with each other and stored in the storage unit 32.

The control unit 31 is constituted by a processor including, for example, a CPU (Central Processing Unit). The control unit 31 functions as a comparison processing unit 311, a notification processing unit 312, a display processing unit 313, and the like, by the processor executing a computer program.

The comparison processing unit 311 performs a comparison process using the sensor value data stored in the storage unit 32 in order to determine the state of the analytical instrument 100. The specific processing by this comparison processing unit 311 will be described later.

The notification processing unit 312 performs processing to notify of an abnormality of the analytical instrument 100 based on the result of the comparison by the comparison processing unit 311. Specifically, when the state of the analytical instrument 100 is determined to be abnormal as a result of the comparison by the comparison processing unit 311, it performs processing to display that effect on the display unit 33. However, the notification by the notification processing unit 312 is not limited to being performed by display on the display unit 33, and may be performed by other means such as audio. Further, the configuration may be such that the notification processing unit 312 provides a notification not only when the state of the analytical instrument 100 is determined to be abnormal, but also when it is determined to be normal.

The display processing unit 313 performs display on the display unit 33 based on the data stored in the storage unit 32. Specifically, it can display the analysis data (chromatogram) stored in the storage unit 32 on the display unit 33, and can also display an image based on the sensor value data stored in the storage unit 32.

### 3. Example of Processing by Comparison Processing Unit

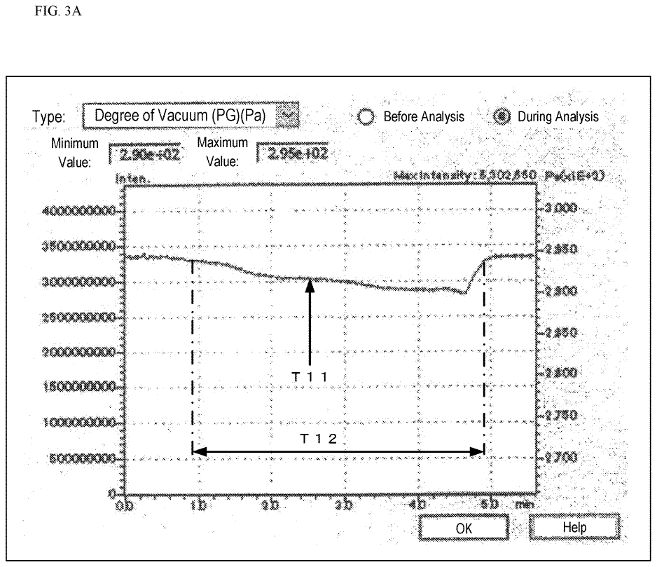

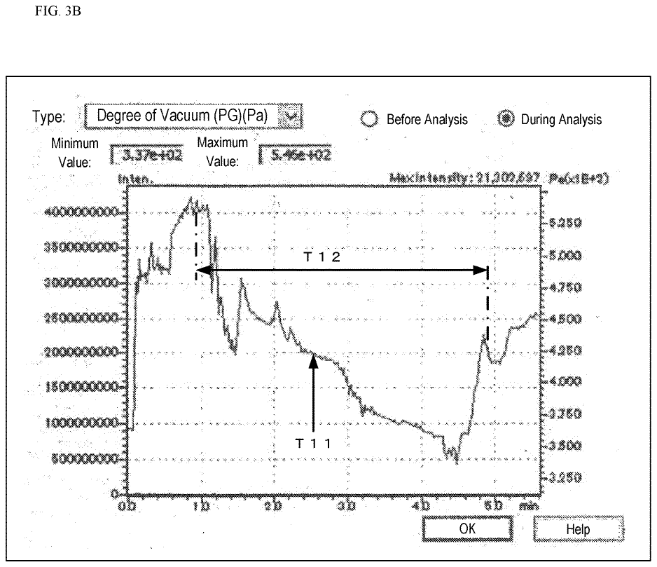

FIG. 3A and FIG. 3B are diagrams for explaining an example of processing by the comparison processing unit 311. FIG. 3A shows sensor value data of the degree of vacuum when the analytical instrument 100 is in a normal state, and FIG. 3B shows sensor value data of the degree of vacuum when the analytical instrument 100 is in an abnormal state. The degree of vacuum represents the temporal change of the sensor value output from the vacuum gauge 25 during each analysis. The processing by the comparison processing unit 311 can be performed by any of the methods exemplified in (3-1) to (3-3) below, using a plurality of pieces of sensor value data obtained from a plurality of analyses performed under the same analysis conditions.

### (3-1) Processing Using Difference in Sensor Values at the Same Analysis Time

With the normal state of the analytical instrument 100 as shown in FIG. 3A as a reference state, the difference between the sensor value at an arbitrary time T11 during analysis in the reference state and the sensor value at the same time T11 during analysis of the sensor value data to be compared as shown in FIG. 3B is calculated by the comparison processing unit 311, and that difference is compared with a threshold value. That is, the processing by the comparison processing unit 311 is performed by comparing the difference in sensor values at the same analysis time (time T11) with a threshold value for a plurality of pieces of sensor value data obtained by performing analysis multiple times under the same analysis conditions.

When comparing the difference in sensor values at the same analysis time (time T11) with a threshold value for a plurality of pieces of sensor value data obtained by performing analysis multiple times under the same analysis conditions, the “same analysis time” may be an arbitrary time during the analysis, or may be a preset time.

### (3-2) Processing Using Value Representing Change in Sensor Value in the Same Analysis Time Range

With the normal state of the analytical instrument 100 as shown in FIG. 3A as a reference state, the difference between a value representing the change in the sensor value in an arbitrary time range T12 during analysis in the reference state and a value representing the change in the sensor value in the same time range T12 during analysis of the sensor value data to be compared as shown in FIG. 3B is calculated by the comparison processing unit 311, and that difference is compared with a threshold value. That is, the processing by the comparison processing unit 311 is performed by comparing the difference in a value representing the change in the sensor value in the same analysis time range (time range T12) with a threshold value for a plurality of pieces of sensor value data obtained by performing analysis multiple times under the same analysis conditions.

In this case, the value representing the change in the sensor value can be calculated using, for example, the average value or standard deviation of the sensor values in the time range T12, but is not limited to such a method and can be calculated by any other arbitrary method.

When comparing the difference in a value representing the change in the sensor value in the same analysis time range (time range T12) with a threshold value for a plurality of pieces of sensor value data obtained by performing analysis multiple times under the same analysis conditions, the “same analysis time range” may be the entire time range from the start to the end of the analysis, or may be a partial time range. In the case of a partial time range, it may be an arbitrary time range during the analysis, or may be a preset time range.

### (3-3) Processing Using Image Representing Sensor Value Data in the Same Analysis Time Range

With the normal state of the analytical instrument 100 as shown in FIG. 3A as a reference state, the difference between an image representing the sensor value data in an arbitrary time range T12 during analysis in the reference state and an image of the sensor value data to be compared in the same time range T12 during analysis as shown in FIG. 3B is calculated by the comparison processing unit 311, and that difference is compared with a threshold value. That is, the processing by the comparison processing unit 311 is performed by comparing the difference between images representing each piece of sensor value data in the same analysis time range (time range T12) with a threshold value for a plurality of pieces of sensor value data obtained by performing analysis multiple times under the same analysis conditions.

In this case, the difference between the images representing each piece of sensor value data can be calculated by, for example, obtaining the difference between values based on each image that has been quantified using image recognition or machine learning, but is not limited to such a method and can be calculated by any other arbitrary method.

When comparing the difference between images representing each piece of sensor value data in the same analysis time range (time range T12) with a threshold value for a plurality of pieces of sensor value data obtained by performing analysis multiple times under the same analysis conditions, the “same analysis time range” may be the entire time range from the start to the end of the analysis, or may be a partial time range. In the case of a partial time range, it may be an arbitrary time range during the analysis, or may be a preset time range.

According to processing such as (3-1) or (3-2), even in a case where the state of the analytical instrument 100 is abnormal but is determined to be normal when the sensor value is compared with a threshold value, it is possible to accurately determine that the state of the analytical instrument 100 is abnormal by comparing the difference in the sensor values or the difference in the value representing the change in the sensor values with a threshold value. Further, according to processing such as (3-3), even in a case where the state of the analytical instrument 100 is abnormal but is determined to be normal when the sensor value is compared with a threshold value, it is possible to accurately determine that the state of the analytical instrument 100 is abnormal by comparing the difference between the images representing each piece of sensor value data with a threshold value.

Note that the sensor value data in the reference state corresponding to FIG. 3A may be, for example, the sensor value data at the time of the first analysis among a plurality of analyses, the sensor value data at the time of the analysis immediately preceding the analysis in which the sensor value data to be compared was obtained, or any sensor value data selected by the user. Further, the sensor value data in the reference state may be calculated by image recognition or machine learning based on the sensor value data at the time of a plurality of analyses.

### 4. Another Example of Processing by Comparison Processing Unit

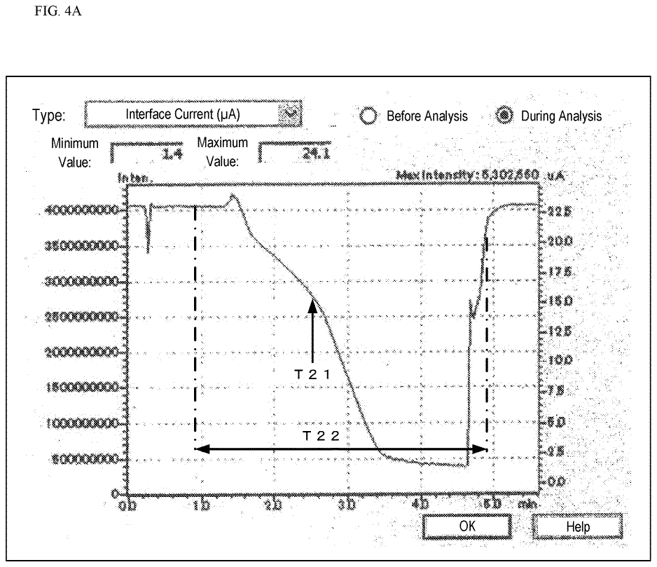

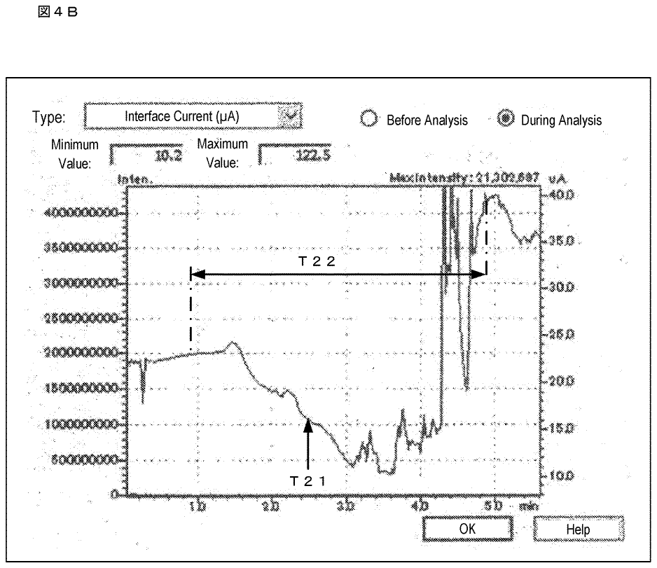

FIG. 4A and FIG. 4B are diagrams for explaining another example of processing by the comparison processing unit 311. FIG. 4A shows sensor value data of the interface current when the analytical instrument 100 is in a normal state, and FIG. 4B shows sensor value data of the interface current when the analytical instrument 100 is in an abnormal state. The interface current represents the temporal change of the sensor value output from the ammeter 26 during each analysis. The processing by the comparison processing unit 311 can be performed by any of the methods exemplified in (4-1) to (4-3) below, using a plurality of pieces of sensor value data obtained from a plurality of analyses performed under the same analysis conditions.

### (4-1) Processing Using Difference in Sensor Values at the Same Analysis Time

With the normal state of the analytical instrument 100 as shown in FIG. 4A as a reference state, the difference between the sensor value at an arbitrary time T21 during analysis in the reference state and the sensor value at the same time T21 during analysis of the sensor value data to be compared as shown in FIG. 4B is calculated by the comparison processing unit 311, and that difference is compared with a threshold value. That is, the processing by the comparison processing unit 311 is performed by comparing the difference in sensor values at the same analysis time (time T21) with a threshold value for a plurality of pieces of sensor value data obtained by performing analysis multiple times under the same analysis conditions.

When comparing the difference in sensor values at the same analysis time (time T21) with a threshold value for a plurality of pieces of sensor value data obtained by performing analysis multiple times under the same analysis conditions, the “same analysis time” may be an arbitrary time during the analysis, or may be a preset time.

### (4-2) Processing Using Value Representing Change in Sensor Value in the Same Analysis Time Range

With the normal state of the analytical instrument 100 as shown in FIG. 4A as a reference state, the difference between a value representing the change in the sensor value in an arbitrary time range T22 during analysis in the reference state and a value representing the change in the sensor value in the same time range T22 during analysis of the sensor value data to be compared as shown in FIG. 4B is calculated by the comparison processing unit 311, and that difference is compared with a threshold value. That is, the processing by the comparison processing unit 311 is performed by comparing the difference in a value representing the change in the sensor value in the same analysis time range (time range T22) with a threshold value for a plurality of pieces of sensor value data obtained by performing analysis multiple times under the same analysis conditions.

In this case, the value representing the change in the sensor value can be calculated using, for example, the average value or standard deviation of the sensor values in the time range T22, but is not limited to such a method and can be calculated by any other arbitrary method.

When comparing the difference in a value representing the change in the sensor value in the same analysis time range (time range T22) with a threshold value for a plurality of pieces of sensor value data obtained by performing analysis multiple times under the same analysis conditions, the “same analysis time range” may be the entire time range from the start to the end of the analysis, or may be a partial time range. In the case of a partial time range, it may be an arbitrary time range during the analysis, or may be a preset time range.

### (4-3) Processing Using Image Representing Sensor Value Data in the Same Analysis Time Range

With the normal state of the analytical instrument 100 as shown in FIG. 4A as a reference state, the difference between an image representing the sensor value data in an arbitrary time range T22 during analysis in the reference state and an image of the sensor value data to be compared in the same time range T22 during analysis as shown in FIG. 4B is calculated by the comparison processing unit 311, and that difference is compared with a threshold value. That is, the processing by the comparison processing unit 311 is performed by comparing the difference between images representing each piece of sensor value data in the same analysis time range (time range T22) with a threshold value for a plurality of pieces of sensor value data obtained by performing analysis multiple times under the same analysis conditions.

In this case, the difference between the images representing each piece of sensor value data can be calculated by, for example, obtaining the difference between values based on each image that has been quantified using image recognition or machine learning, but is not limited to such a method and can be calculated by any other arbitrary method.

When comparing the difference between images representing each piece of sensor value data in the same analysis time range (time range T22) with a threshold value for a plurality of pieces of sensor value data obtained by performing analysis multiple times under the same analysis conditions, the “same analysis time range” may be the entire time range from the start to the end of the analysis, or may be a partial time range. In the case of a partial time range, it may be an arbitrary time range during the analysis, or may be a preset time range.

According to processing such as (4-1) or (4-2), even in a case where the state of the analytical instrument 100 is abnormal but is determined to be normal when the sensor value is compared with a threshold value, it is possible to accurately determine that the state of the analytical instrument 100 is abnormal by comparing the difference in the sensor values or the difference in the value representing the change in the sensor values with a threshold value. Further, according to processing such as (4-3), even in a case where the state of the analytical instrument 100 is abnormal but is determined to be normal when the sensor value is compared with a threshold value, it is possible to accurately determine that the state of the analytical instrument 100 is abnormal by comparing the difference between the images representing each piece of sensor value data with a threshold value.

Note that the sensor value data in the reference state corresponding to FIG. 4A may be, for example, the sensor value data at the time of the first analysis among a plurality of analyses, the sensor value data at the time of the analysis immediately preceding the analysis in which the sensor value data to be compared was obtained, or any sensor value data selected by the user. Further, the sensor value data in the reference state may be calculated by image recognition or machine learning based on the sensor value data at the time of a plurality of analyses.

### 5. Example of Processing by Display Processing Unit

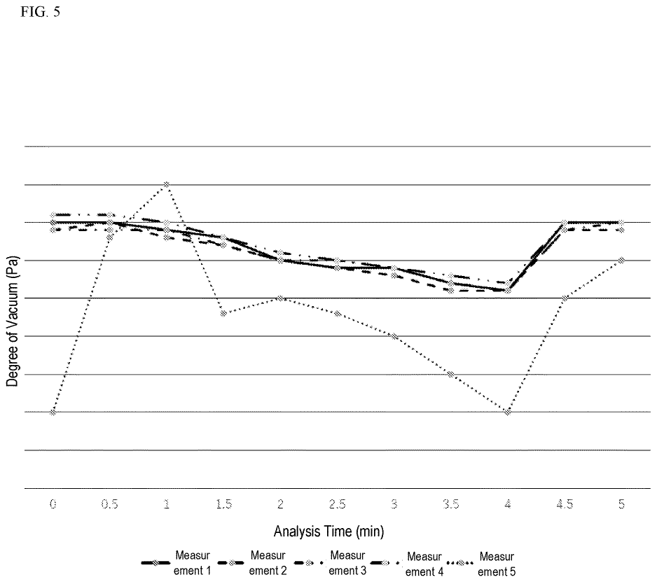

FIG. 5 is a diagram for explaining an example of processing by the display processing unit 313. In this example, images representing a plurality of pieces of sensor value data obtained by performing analysis multiple times under the same analysis conditions are displayed superimposed on the display unit 33 by the display processing unit 313. Here, “displayed superimposed” means being displayed with reference to the same vertical and horizontal axes, and the “image” representing the sensor value data is a graph displayed with reference to the same vertical and horizontal axes.

Specifically, with the degree of vacuum on the vertical axis and the analysis time on the horizontal axis, each sensor value obtained in the same analysis time range from five analyses, measurements 1 to 5, is plotted at constant time intervals (e.g., every 0.5 min), thereby displaying images representing each piece of sensor value data superimposed on the display unit 33. However, the vertical axis is not limited to the degree of vacuum and may be another sensor value such as the interface current.

The “same analysis time range” may be the entire time range from the start to the end of the analysis, or may be a partial time range. In the case of a partial time range, it may be an arbitrary time range during the analysis, or may be a preset time range.

The state of the analytical instrument 100 can be determined based on an image as exemplified in FIG. 5. For example, the user may determine the state of the analytical instrument 100 by visually observing the image, or the state of the analytical instrument 100 may be determined by image processing. The image processing can be exemplified by a process of comparing a peak value or a peak area in the image with a threshold value, but is not limited to this.

In this way, by determining the state of the analytical instrument 100 based on an image as exemplified in FIG. 5 and combining the determination result with the result of the processing by the comparison processing unit 311, the state of the analytical instrument 100 can be determined with even higher accuracy.

### 6. Another Example of Processing by Display Processing Unit

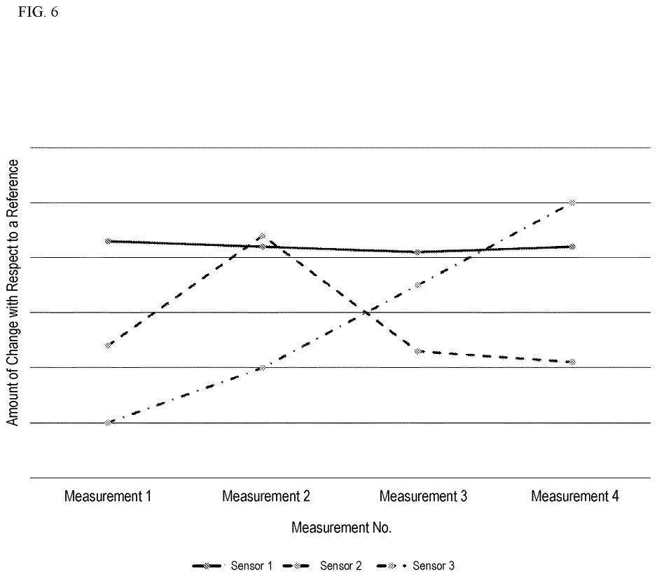

FIG. 6 is a diagram for explaining another example of processing by the display processing unit 313. In this example, for a plurality of pieces of sensor value data obtained by performing analysis multiple times under the same analysis conditions, an image representing the amount of change in the sensor value at the same analysis time in chronological order is displayed on the display unit 33 by the display processing unit 313. The “same analysis time” may be an arbitrary time during the analysis, or may be a preset time.

Specifically, the amount of change in the sensor value with respect to a reference is shown on the vertical axis, corresponding to a horizontal axis where each of the measurements 1 to 4 is arranged in chronological order. As for the sensor values, the output values from sensors 1 to 3 are plotted, but output values from two or fewer sensors, or four or more sensors, may be plotted. Note that the sensors 1 to 3 can be exemplified by the pressure gauge 16, the vacuum gauge 25, or the ammeter 26.

The state of the analytical instrument 100 can be determined based on an image as exemplified in FIG. 6. For example, the user may determine the state of the analytical instrument 100 by visually observing the image, or the state of the analytical instrument 100 may be determined by image processing. The image processing can be exemplified by a process of comparing a peak value or a peak area in the image with a threshold value, but is not limited to this.

In this way, by determining the state of the analytical instrument 100 based on an image as exemplified in FIG. 6 and combining the determination result with the result of the processing by the comparison processing unit 311, the state of the analytical instrument 100 can be determined with even higher accuracy.

### 7. Modifications

In the above embodiments, the analytical instrument 100 in which the liquid chromatograph 1 and the mass spectrometer 2 are combined has been described. However, the present invention is applicable to an analytical instrument 100 including at least one of a chromatograph and a mass spectrometer. Therefore, the analytical instrument 100 may be an apparatus in which a gas chromatograph and a mass spectrometer are combined. Further, the analytical instrument 100 may be an apparatus consisting only of a liquid chromatograph or a gas chromatograph, or may be an apparatus consisting only of a mass spectrometer.

The sensor value data to be compared may be read out from the storage unit 32 after the analysis and processed by the comparison processing unit 311, or may be read out from the storage unit 32 in real time during the analysis and processed by the comparison processing unit 311.

The sensor value data is not limited to the pump pressure detected by the pressure gauge 16, the degree of vacuum detected by the vacuum gauge 25, or the interface current detected by the ammeter 26, and may consist of output values from various other sensors.

### 8. Aspects

It will be understood by those skilled in the art that the plurality of exemplary embodiments described above are specific examples of the following aspects.

(Item 1) An analytical instrument according to one aspect may be:
an analytical instrument including at least one of a chromatograph and a mass spectrometer, comprising:
a sensor that detects a state of the analytical instrument and outputs a sensor value corresponding to the state;
a storage unit that stores sensor value data representing a temporal change of the sensor value with an elapse of analysis time; and
a comparison processing unit that compares, for a plurality of pieces of the sensor value data obtained by performing analysis a plurality of times under the same analysis conditions, a difference in the sensor value at the same analysis time, or a difference in a value representing a change in the sensor value in the same analysis time range, with a threshold value.

According to the analytical instrument of Item 1, instead of comparing the sensor value with a threshold value, the state of the analytical instrument can be determined with higher accuracy by comparing, for a plurality of pieces of sensor value data obtained by performing analysis multiple times under the same analysis conditions, a difference in the sensor value at the same analysis time, or a difference in a value representing a change in the sensor value in the same analysis time range, with a threshold value. That is, even in a case where the state of the analytical instrument is abnormal but is determined to be normal when the sensor value is compared with a threshold value, it is possible to accurately determine that the state of the analytical instrument is abnormal by comparing the difference in the sensor values or the difference in the value representing the change in the sensor values with a threshold value.

(Item 2) An analytical instrument according to another aspect may be:
an analytical instrument including at least one of a chromatograph and a mass spectrometer, comprising:
a sensor that detects a state of the analytical instrument and outputs a sensor value corresponding to the state;
a storage unit that stores sensor value data representing a temporal change of the sensor value with an elapse of analysis time; and
a comparison processing unit that compares, for a plurality of pieces of the sensor value data obtained by performing analysis a plurality of times under the same analysis conditions, a difference between images representing each piece of sensor value data in the same analysis time range, with a threshold value.

According to the analytical instrument of Item 2, instead of comparing the sensor value with a threshold value, the state of the analytical instrument can be determined with higher accuracy by comparing, for a plurality of pieces of sensor value data obtained by performing analysis multiple times under the same analysis conditions, a difference between images representing each piece of sensor value data in the same analysis time range, with a threshold value. That is, even in a case where the state of the analytical instrument is abnormal but is determined to be normal when the sensor value is compared with a threshold value, it is possible to accurately determine that the state of the analytical instrument is abnormal by comparing the difference between the images representing each piece of sensor value data with a threshold value.

(Item 3) The analytical instrument according to Item 1 or 2 may further comprise:
a notification processing unit that notifies of an abnormality of the analytical instrument based on a result of the comparison by the comparison processing unit.

According to the analytical instrument of Item 3, when the state of the analytical instrument is determined to be abnormal, the user is notified of that fact. Therefore, it is possible to notify the user in an easy-to-understand manner that an accurate analysis result has not been obtained.

(Item 4) The analytical instrument according to Item 1 or 2 may further comprise:
a display processing unit that causes images representing each piece of the sensor value data in the same analysis time range to be displayed superimposed, for a plurality of pieces of the sensor value data obtained by performing analysis a plurality of times under the same analysis conditions.

According to the analytical instrument of Item 4, by causing images representing each piece of the sensor value data in the same analysis time range to be displayed superimposed, the state of the analytical instrument can be determined based on that image. By combining that determination result with the result of the processing by the comparison processing unit, the state of the analytical instrument can be determined with even higher accuracy.

(Item 5) The analytical instrument according to Item 1 or 2 may further comprise:
a display processing unit that causes an image representing an amount of change in the sensor value at the same analysis time in chronological order to be displayed, for a plurality of pieces of the sensor value data obtained by performing analysis a plurality of times under the same analysis conditions.

According to the analytical instrument of Item 5, by causing an image representing the amount of change in the sensor value at the same analysis time in chronological order to be displayed, the state of the analytical instrument can be determined based on that image. By combining that determination result with the result of the processing by the comparison processing unit, the state of the analytical instrument can be determined with even higher accuracy.

### REFERENCE SIGNS LIST

1 Liquid chromatograph
2 Mass spectrometer
3 Control device
16 Pressure gauge
25 Vacuum gauge
26 Ammeter
31 Control unit
32 Storage unit
33 Display unit
100 Analytical instrument
311 Comparison processing unit
312 Notification processing unit
313 Display processing unit

1. An analytical instrument including at least one of a chromatograph and a mass spectrometer, the analytical instrument comprising:
a sensor that detects a state of the analytical instrument and outputs a sensor value corresponding to the state;
a storage unit that stores sensor value data representing a temporal change of the sensor value in all time range from the start to the end of the analysis with an elapse of analysis time; and
a comparison processing unit that compares, for a plurality of pieces of the sensor value data obtained by performing analysis a plurality of times under the same analysis conditions, a difference in the sensor value at the same analysis time, which is the same point on the time axis in all the time range, or a difference in the average value or standard deviation of the sensor value in the same analysis time range, which is the same range on the time axis corresponding to a part or the entirety of all the time range, with a threshold value to detect an abnormality in the pressure of the analytical instrument.

2. An analytical instrument including at least one of a chromatograph and a mass spectrometer, the analytical instrument comprising:
a sensor that detects a state of the analytical instrument and outputs a sensor value corresponding to the state;
a storage unit that stores sensor value data representing a temporal change of the sensor value in all time range from the start to the end of the analysis with an elapse of analysis time; and
a comparison processing unit that compares, for a plurality of pieces of the sensor value data obtained by performing analysis a plurality of times under the same analysis conditions, a difference in a numerical value obtained by quantifying an image on a graph representing each piece of sensor value data in the same analysis time range, which is the same range on the time axis corresponding to a part or the entirety of all the time range, with a threshold value to detect an abnormality in the pressure of the analytical instrument.

3. The analytical instrument according to claim 1, further comprising:
a notification processing unit that notifies of a pressure an abnormality of the analytical instrument based on a result of the comparison by the comparison processing unit.

4. The analytical instrument according to claim 1, further comprising:
a display processing unit that causes images representing each piece of the sensor value data in the same analysis time range, which is the same range on the time axis corresponding to a part or the entirety of all the time range, for a plurality of pieces of the sensor value data obtained by performing analysis a plurality of times under the same analysis conditions, to be displayed superimposed on a graph having the sensor value data as the vertical axis.

5. The analytical instrument according to claim 1, further comprising:
a display processing unit that causes an image representing an amount of change in the sensor value with respect to a reference at the same analysis time, which is the same point on the time axis in all the time range, in chronological order, to be displayed on a graph having the amount of change as the vertical axis, for a plurality of pieces of the sensor value data obtained by performing analysis a plurality of times under the same analysis conditions.

6. The analytical instrument according to claim 2, further comprising:
a notification processing unit that notifies of a pressure abnormality of the analytical instrument based on a result of the comparison by the comparison processing unit.

7. The analytical instrument according to claim 2, further comprising:
a display processing unit that causes images representing each piece of the sensor value data in the same analysis time range, which is the same range on the time axis corresponding to a part or the entirety of all the time range, for a plurality of pieces of the sensor value data obtained by performing analysis a plurality of times under the same analysis conditions, to be displayed superimposed on a graph having the sensor value data as the vertical axis.

8. The analytical instrument according to claim 2, further comprising:
a display processing unit that causes an image representing an amount of change in the sensor value with respect to a reference at the same analysis time, which is the same point on the time axis in all the time range, in chronological order, to be displayed on a graph having the amount of change as the vertical axis, for a plurality of pieces of the sensor value data obtained by performing analysis a plurality of times under the same analysis conditions.
